(19) United States
(12) Patent Application Publication
(10) Pub. No.: US 2007/0290476 A1
(43) Pub. Date: Dec. 20, 2007

(54) Trailer

(76) Inventor: Louis Chuang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/745,494

(22) Filed: May 8, 2007

(30) Foreign Application Priority Data
May 22, 2006 (TW) 95118103

(51) Int. Cl. B62K 27/00

(52) U.S. Cl. 280/204

(57) ABSTRACT

A trailer includes a carrying unit, at least one rod, at least one shackle and at least one elastic element. The rod is connected to the carrying unit. The rod includes a recess for receiving a hook tip connected to a bicycle. The shackle is movable on the rod between a locking position and a releasing position. In the locking position, the shackle shelters a portion of the recess. In the releasing position, the shackle fully opens the recess. The elastic element is mounted on the rod for keeping the shackle in the locking position.

### BACKGROUND OF INVENTION

1. Field of Invention

The present invention relates to a trailer for connection to a bicycle.

2. Related Prior Art

Disclosed in Taiwanese Patent M278631 is a trailer for connection to a bicycle. The bicycle includes a shaft 10 formed with a middle portion 11 for supporting a rear wheel and two terminal portions 13 for supporting the trailer. Two rings 14 are mounted on the shaft 10, each located between the middle portion 11 and a related one of the terminal portions 13. Each of the terminal portions 13 of the shaft 10 is formed with a ball.

The trailer includes a carrying unit 20 and two hooking units 30 each including two plates 31. Each of the plates 31 includes a cutout 311, upper and lower slots 312. The lower slot 312 of each of the plates 31 is in communication with enlarged first and second apertures 313 at two ends. A hook 32 is located between the plates 31. The hook 32 is pivotally connected to the plates 31 by a threaded bolt 34 inserted through the upper slots 312 and engaged with a nut 35. A latch 33 includes an enlarged head 334 formed at a first end and a screw hole 331 defined in a second end. The latch 33 gets bigger from the first end to the second end. The latch 33 is inserted through the lower slots 312. A threaded bolt 332 is driven in the screw hole 331. An elastic device 333 is mounted on the latch 33 and compressed between the enlarged head 334 and one of the plates 31.

To connect the trailer to the bicycle, the plates 331 are located above the terminal portions 13 of the shaft 10 that are in turn inserted into the cutouts 311. The latches 33 are pulled and moved along the lower slots 312 from the first apertures 313 to the second apertures 313 so that the hooks 32 hook the terminal portions 13 of the shaft 10. The latches 33 are released. Immediately, the latches 33 are returned by the elastic devices 333 so that latches 33 cannot be moved along the lower slots 312. Thus, the terminal portions 13 of the shaft 10 are firmly hooked by the hooking units 30.

It is however troublesome for a user to hook the hooking units 30 on the terminal portions 13 of the shaft 10. The user must locate the plates 31 above the terminal portions 13 of the shaft 10, pull the latches 33 and move the same to the second apertures 313 along the lower slots 312 before he or she can release the latches 33. Meanwhile, the user must press the plates 31 on the terminal portions 13 of the shaft 10 lest the plates 31 might accidentally be lifted from the terminal portions 13 of the shaft 10. It is also troublesome to detach the hooking units 30 from the terminal portions 13 of the shaft 13.

The present invention is therefore intended to obviate or at least alleviate the problems encountered in prior art.

### SUMMARY OF INVENTION

According to the present invention, a trailer includes a carrying unit, at least one rod, at least one shackle and at least one elastic element. The rod is connected to the carrying unit. The rod includes a recess for receiving a hook tip connected to a bicycle. The shackle is movable on the rod between a locking position and a releasing position. In the locking position, the shackle shelters a portion of the recess. In the releasing position, the shackle fully opens the recess. The elastic element is mounted on the rod for keeping the shackle in the locking position.

The primary advantage of the trailer according to the present invention is easy operation. A user moves the shackles to the releasing position, inserting the hook tips into the recesses, and releases the shackles. Then, the elastic elements automatically return the shackles to the locking position.

Other advantages and features of this invention will become apparent from the following description referring to the attached drawings.

### BRIEF DESCRIPTION OF DRAWINGS

The present invention will be described via the detailed illustration of three embodiments referring to the drawings.

FIG. 1 is a perspective view of a trailer according to the first embodiment of the present invention.

FIG. 2 is an exploded view of the trailer shown in FIG. 1.

FIG. 3 is a top view of a bicycle connected to the trailer of FIG. 1.

FIG. 4 is a cross-sectional view of the trailer shown in FIG. 3.

FIG. 5 is another cross-sectional view of the trailer shown in FIG. 3.

FIG. 6 is another cross-sectional view of the trailer shown in FIG. 3.

FIG. 7 is a cross-sectional view of the trailer taken along a line 7-7 in FIG. 1.

FIG. 8 is an enlarged partial view of the trailer shown in FIG. 7.

FIG. 9 is an exploded view of a trailer according to the second embodiment of the present invention.

FIG. 10 is a perspective view of a trailer according to the third embodiment of the present invention.

FIG. 11 is a perspective view of a bicycle equipped with a trailer shown in FIG. 10.

### DETAILED DESCRIPTION OF EMBODIMENTS

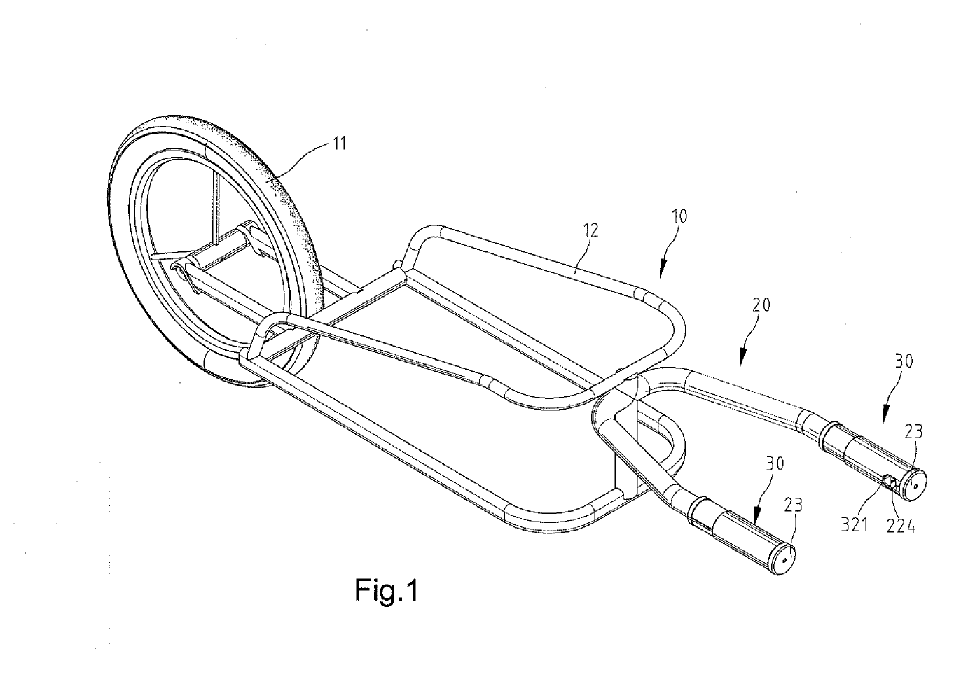

Referring to FIGS. 1 through 8, there is a trailer 10 according to a first embodiment of the present invention. The trailer 10 can be connected to and detached from a bicycle 50. The bicycle 50 is equipped with two hook tips 51.

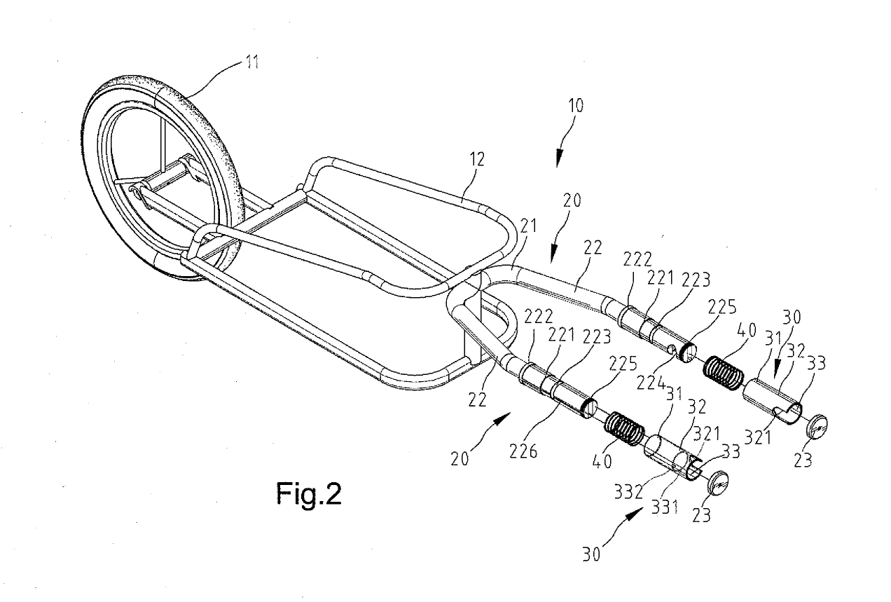

Referring to FIGS. 1 and 2, the trailer 10 includes a carrying unit 12, a wheel 11 connected to the carrying unit 12, two rods 20 connected to the carrying unit 12, two shackles 30 mounted on the rods 20 for locking the hook tips 51 and two elastic elements 40 for biasing the shackles 30.

Each of the rods 20 includes a first end 21 connected to the carrying unit 12, a second end 22 formed with a thread 225, annular shoulders 221 and 222 formed thereon, an annular groove 223 defined therein, a recess 224 defined therein and a longitudinal groove 226 in communication with the annular groove 223. The annular shoulder 221 is located between the annular shoulder 222 and the annular groove 223.

Each of the elastic elements 40 is preferably a helical spring mounted on a related one of the rods 20 against the annular shoulder 221.

Each of the shackles 30 includes a first end 31, a second end 32, a cutout 321 defined in the second end 32, a tunnel 33 defined therein, an annular shoulder 331 formed on an internal side thereof and a boss 332 formed on the internal side thereof.

Each of the shackles 30 is mounted on a related one of the rods 20, with the annular shoulder 331 pressed against a related one of the elastic element 40, with the boss 332 movably disposed in the longitudinal groove 226.

There are two restraints 23 each attached to the second end 22 of a related one of the rods 20. Therefore, the shackles 30 are retained on the rods 20, between the annular shoulders 222 and the restraints 23. Each of the restraints 23 is preferably a nut engaged with the thread 225 formed at the second end 22 of a related one of the rods 20.

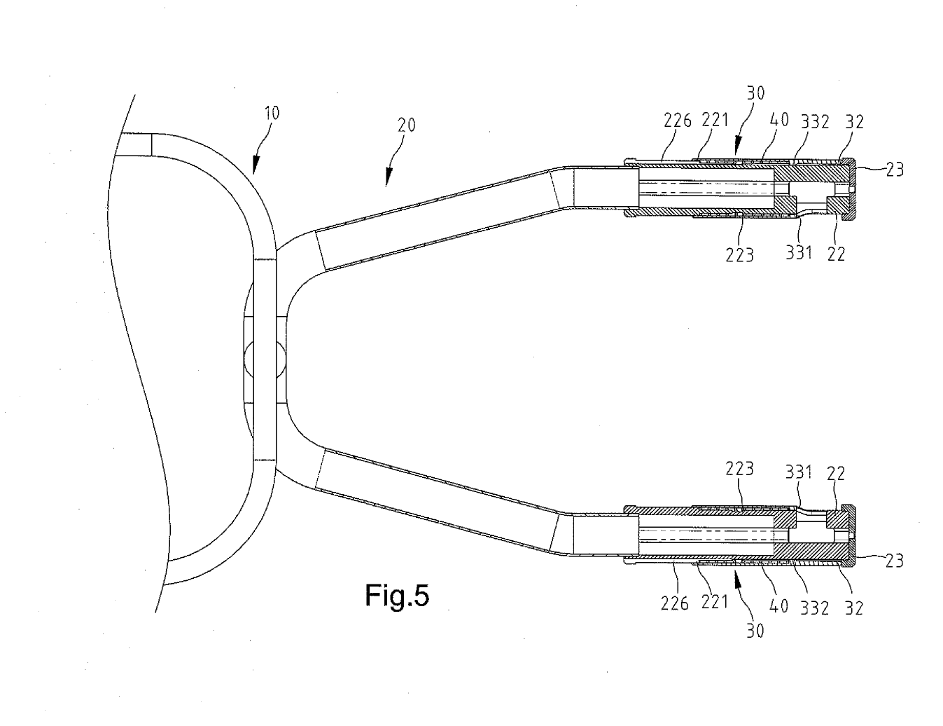

Referring to FIG. 5, the shackles 30 are retained on a locking position by the elastic elements 40. Each of the shackles 30 shelters a portion of a related one of the recesses 224.

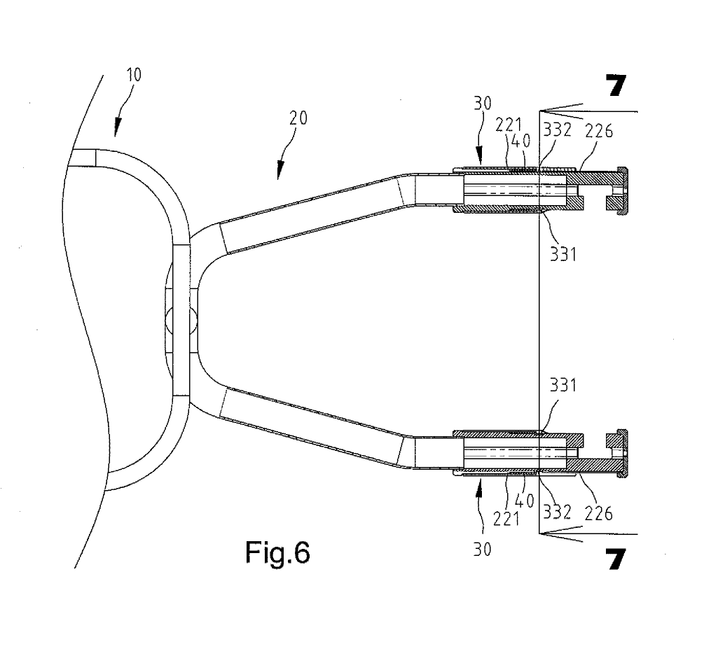

Referring to FIG. 6, a user can move the shackles 30 to a releasing position where the shackles 30 fully open the recesses 224. Therefore, the user can insert the hook tips 51 into the recesses 224. The elastic elements 40 are further loaded.

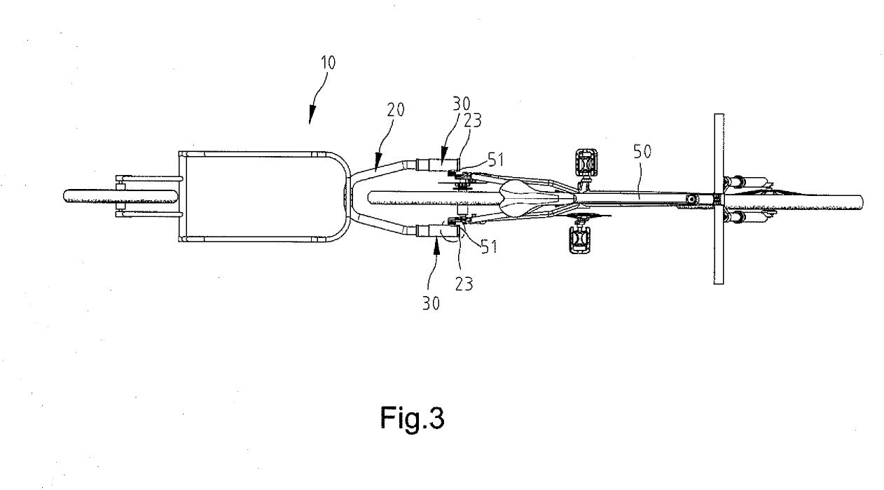

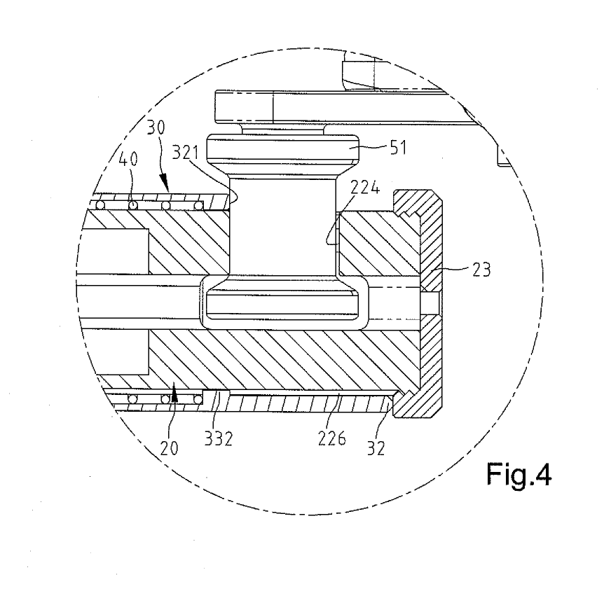

Referring to FIGS. 3 and 4, the shackles 30 are released from the user before they are returned to the locking position by the elastic elements 40. The hook tips 51 are retained in the recesses 224 of the rods 20 by the shackles 30. The trailer 10 is attached to the bicycle 50.

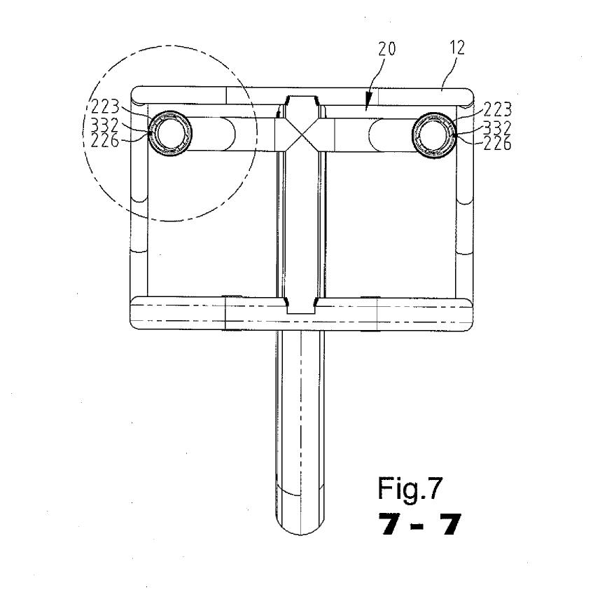

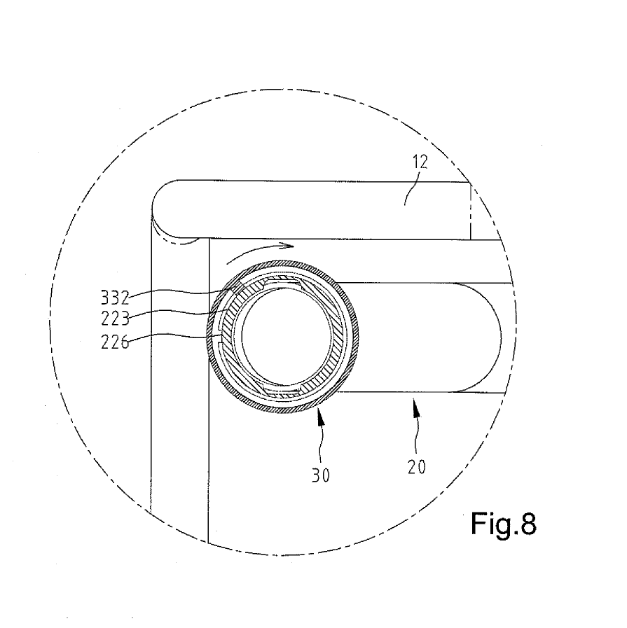

Referring to FIGS. 7 and 8, the user can turn the shackles 30 around the rods 20 for a small angle so that the bosses 332 are moved into the annular grooves 223 from the longitudinal grooves 226. Thus, the shackles 30 cannot be moved along the rods 20. In other words, the shackles 30 are retained in the locking position.

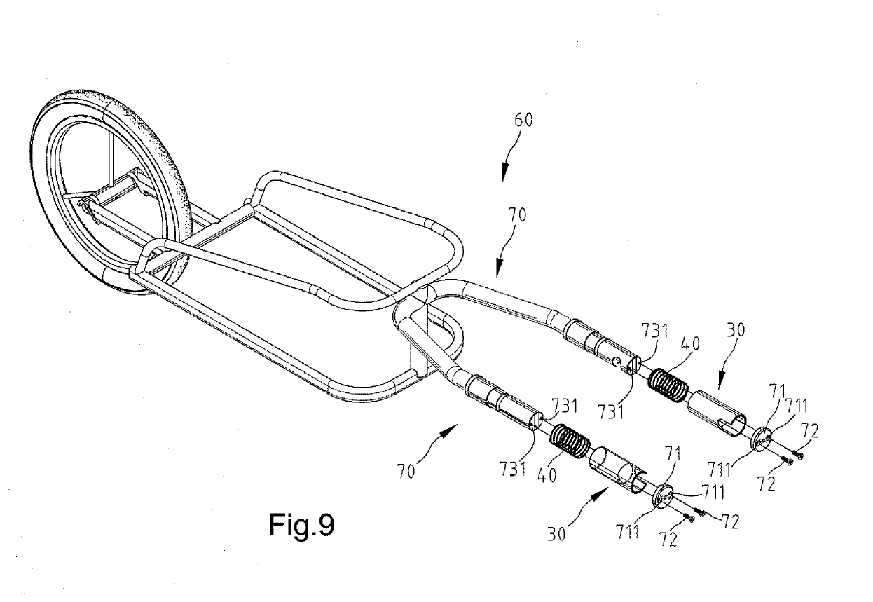

Referring to FIG. 9, there is a trailer 60 according to a second embodiment of the present invention. The trailer 60 is like the trailer 10 except several things. Firstly, each of the rods 20 includes two screw holes 731 instead of the thread 225. Secondly, two restraints 71 are used instead of the restraints 23. Each of the restraints 71 is preferably a disc with two apertures 711 defined therein. Thirdly, a threaded bolt 72 is driven in each of the screw holes 731 through a related one of the apertures 711. Thus, the restraints 71 are attached to the rods 20.

The trailer according to the present exhibits advantages over the conventional trailer discussed in the RELATED PRIOR ART. Firstly, its operation is easy. The user moves the shackles 30 to the releasing position, inserts the hook tips 51 into the recesses 224, and releases the shackles 30. Then, the elastic elements 40 automatically return the shackles 30 to the locking position.

Secondly, the connection of the rods 20 to the hook tips 51 is firm. The shackles 30 can be turned on the rods 20 so that the bosses 332 are moved into the annular grooves 223. Thus, the shackles 30 cannot be moved along the rods 20. That is, the shackles 30 are retained on the locking position.

Thirdly, it is easy for the user to retain the shackles 30 in the locking position without having to carry the rods 20 or the hook tips 51.

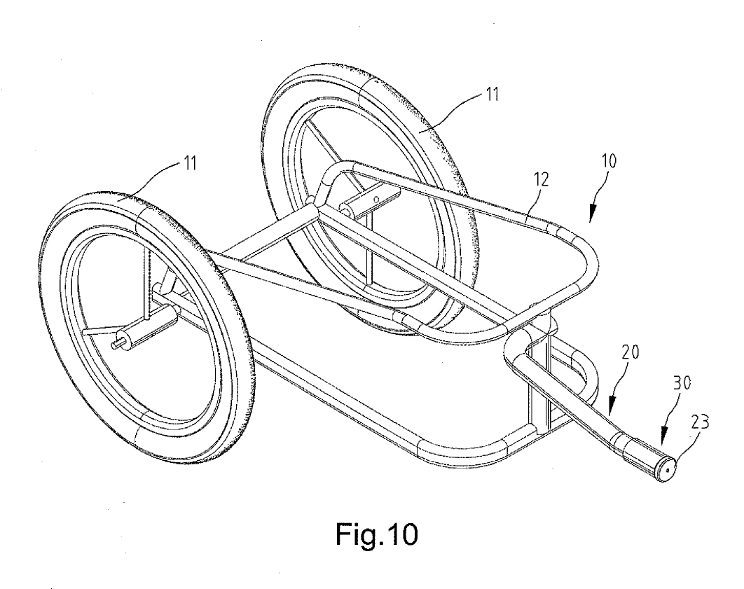

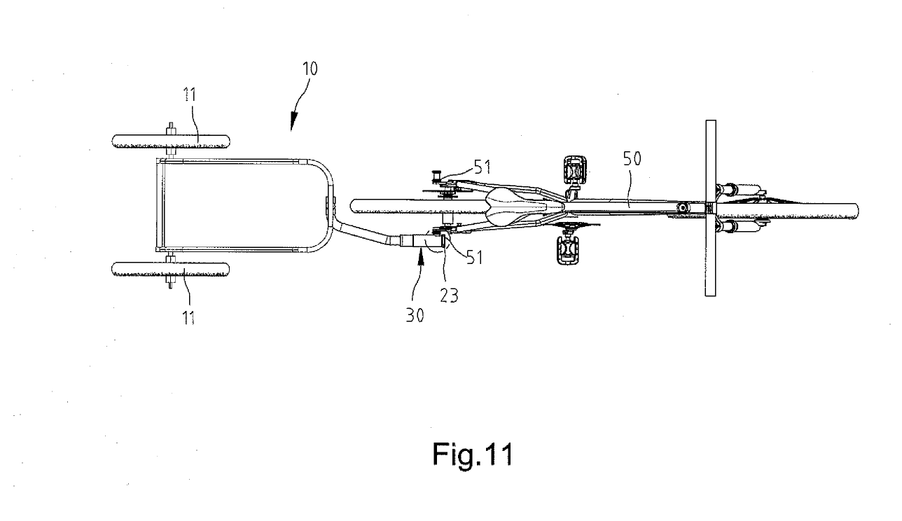

Referring to FIGS. 10 and 11, there is shown a bicycle equipped with a trailer according to a third embodiment of the present invention. The third embodiment is identical to the first embodiment except two things. Firstly, there is only one rod 20 and shackle 30 instead of two rods 20 and shackles 30. Secondly, there are two wheels 11 instead of one.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A trailer comprising:
at least one rod comprising a recess for receiving a hook tip connected to a bicycle;
at least one shackle movable on the rod between a locking position for sheltering a portion of the recess and a releasing position for fully opening the recess; and
at least one elastic element mounted on the rod for keeping the shackle in the locking position.

2. The trailer according to claim 1 wherein the shackle comprises a cutout for receiving the hook tip.

3. The trailer according to claim 1 wherein the rod comprises an annular shoulder pressed against the elastic element.

4. The trailer according to claim 1 wherein the rod comprises an annular shoulder for restraining the shackle.

5. The trailer according to claim 1 wherein the shackle comprises a tunnel for receiving the rod.

6. The trailer according to claim 5 wherein the shackle comprises an annular shoulder formed on an internal side thereof and pressed against the elastic element.

7. The trailer according to claim 5 wherein the shackle comprises a boss formed on an internal side thereof, and the rod comprises a longitudinal groove for receiving the boss of the rod.

8. The trailer according to claim 7 wherein each of the rod comprises an annular groove into which the boss of the shackle is movable from the longitudinal groove thereof, thus keeping the shackle in the locking position.

9. The trailer according to claim 5 comprising at least one restraint attached to the rod for retaining the shackle on the rod.

10. The trailer according to claim 9 wherein the restraint is a nut, and the rod comprises a thread for engagement with the nut.

11. The trailer according to claim 9 wherein the restraint is a disc attached to the rod.

12. The trailer according to claim 11 comprising at least one threaded bolt driven into the rod through the disc.

13. The trailer according to claim 12 wherein the rod comprises a screw hole for receiving the threaded bolt.

14. The trailer according to claim 13 wherein the disc comprises an aperture for receiving the threaded bolt.

15. A trailer comprising:
two rods each comprising a recess for receiving a hook tip connected to a bicycle;
two shackles each movable on a related one of the rods between a locking position for sheltering a portion of the recess of a related one of the rods and a releasing position for fully opening the recess of a related one of the rods; and
two elastic elements mounted on the rods for keeping the shackles in the locking position.
